(19) United States
(12) Patent Application Publication
(10) Pub. No.: US 2006/0000327 A1
(43) Pub. Date: Jan. 5, 2006

(54) Food processor with a blade disk having two-height blades

(75) Inventor: Wei-Chih Lin, Banchiao City (TW)

Correspondence Address: TROXELL LAW OFFICE PLLC, 5205 LEESBURG PIKE, SUITE 1404, FALLS CHURCH, VA, 22041, US

(73) Assignees: Wei-Chih Lin; Pin-Huang Wu

(21) Appl. No.: 10/878,991

(22) Filed: Jun. 30, 2004

(51) Int. Cl. B26D 7/00

(52) U.S. Cl. 83/355; 83/356.3

(57) ABSTRACT

A the food processor includes a base, a lower cap, a blade disk and a top cap which has a feeding tube so as to feed vegetables and/or fruits therethrough by a plunger. The blade disk includes lower blades at inner positions and higher blades at outer positions. Two stepped gaps are defined between the feeding tube and the blades of the blade disk so that the particles such as peels and seeds which are not cut by the lower blades can be cut by the higher blades.

### FIELD OF THE INVENTION

The present invention relates to a food processor whose blade disk having lower blades at inner positions and higher blades at outer positions so as to process the food completely.

### BACKGROUND OF THE INVENTION

Recently, people acknowledge the importance of having organic food and in order to meet the requirements for processing the organic food, different types of food processors are developed such that the users may have fresh vegetables and fruits directly.

FIG. 7 shows a conventional food processor which includes a top cap “a1” with a feeding tube “a2” connected to the top cap “a1” and a blade disk “a3” is located beneath the feeding tube “a2”. A plurality of blades “a4” of equal height are connected to the blade disk “a3” and a gap of about 0.3 mm is defined between the blade disk “a3” and a bottom of the feeding tube “a2”. Vegetables and/or fruits are fed in the space “a5” and cut by the blades which rotate at a high speed so as to obtain juice and fine particles of the vegetables and/or fruits. This is used by the conventional food processors and functioned well when the fruits have no peels and seeds. Nevertheless, the peels and seeds of the vegetables are pushed outward by the rotation of the blade disk “a3” and moved into the gaps “a4”. These peels are thin and soft and the seeds are tiny and stiff so that they may not be cut and are collected to collection box. There are many kinds of nutrition in the peels and seeds and these kinds of nutrition can not be absorbed by the users.

The present invention intends to provide a food processor wherein the blade disk has lower blades at inner positions and higher blades at outer positions such that the food can be cut twice to improve the shortcomings of the conventional food processors.

### SUMMARY OF THE INVENTION

The present invention relates to an improvement for a food processor wherein the blade disk includes lower blades at inner positions and higher blades at outer positions. Two stepped gaps are defined between the feeding tube and the blades of the blade disk such that the food after being cut by the lower blades can be further cut by the higher blades.

In order to achieve the purpose mentioned above, the food processor of the present invention includes a base, a lower cap, a blade disk and a top cap which has a feeding tube so as to feed vegetables and/or fruits therethrough by a plunger. The base has a motor received therein and the blade disk is connected to a connection portion of the motor. The blade disk includes lower blades at inner positions and higher blades at outer positions. Two stepped gaps are defined between the feeding tube and the blades of the blade disk so as to cut the vegetables and/or fruits twice.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the food processor of the present invention;

FIG. 2 is a side view to show the food processor of the present invention;

FIG. 3 is a perspective view to show the blade disk of the present invention;

FIG. 4 is a cross sectional view to show the blade disk of the present invention;

FIG. 5 shows the stepped gaps between the feeding tube and the blades of the blade disk;

FIG. 5A is an enlarged view to show the two gaps in FIG. 5;

FIG. 6 shows the food is cut twice when passing through the two stepped gaps, and

FIG. 7 is a cross sectional view to show a conventional food processor.

### DETAILED DESCRIPTION OF THE PREFERRED EMBODIMENT

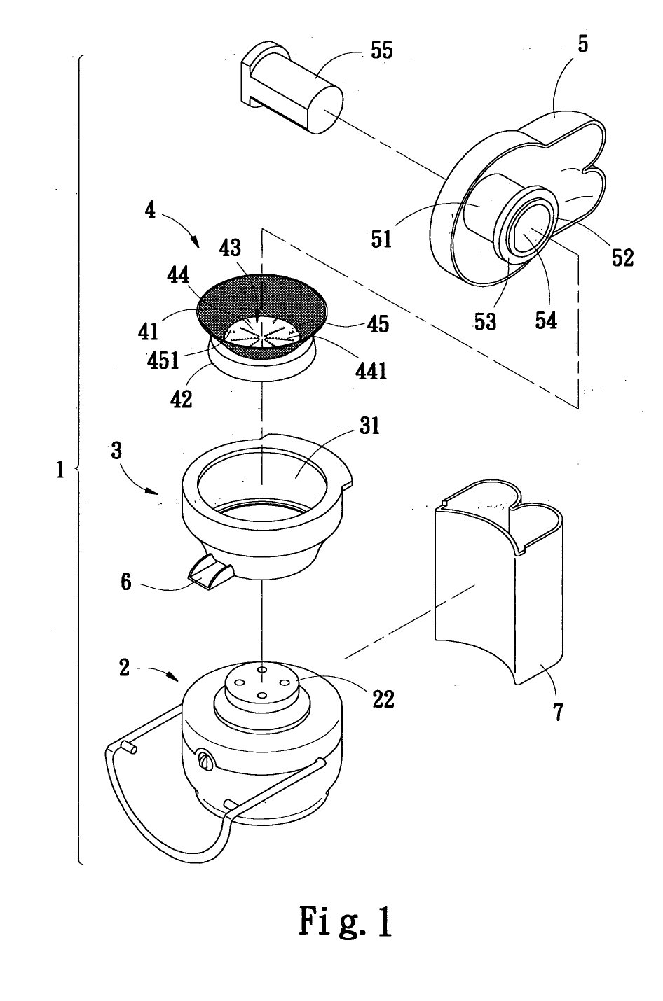

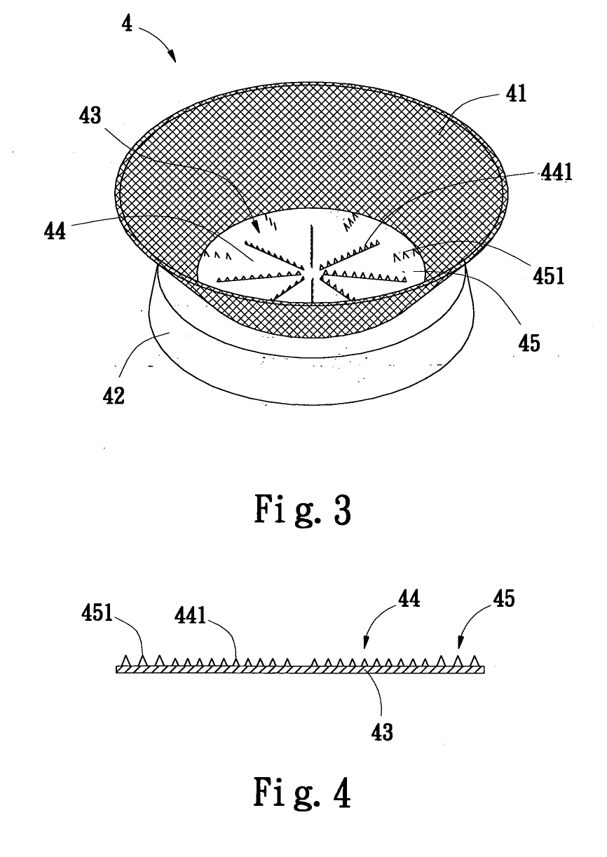

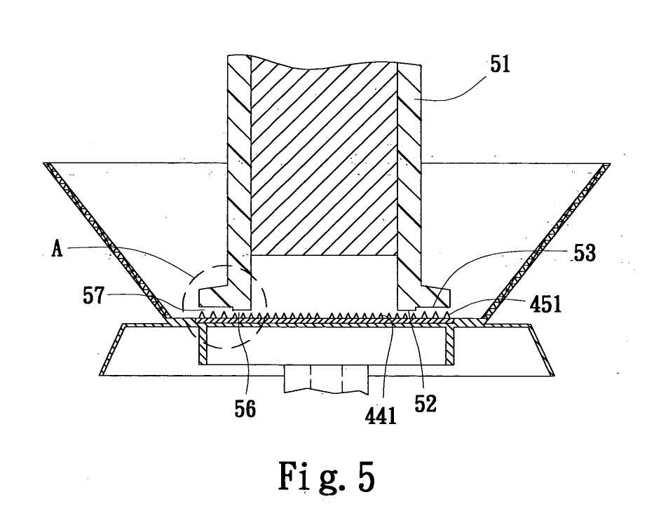

Referring to FIGS. 1 to 4, the food processor 1 of the present invention comprises a base 2, a lower cap 3, a blade disk 4 and a top cap 5.

The top cap 5 has a cylindrical feeding tube 51 which has a polygonal through hole 54 and two stepped end surfaces 52, 53 are defined in an bottom of the feeding tube 51. The polygonal through hole 54 is defined through the feeding tube 51 such that a plunger 55 having a complementary contour is movably inserted in the through hole 54 in the feeding tube 51 to feed vegetables and/or fruits into the lower cap 3.

The lower cap 3 has a space 31 defined therein and the base 2 has a motor 21 received therein. The motor 21 has a connection portion 22 which is connected to the blade disk 4, and so the blade disk 4 is received within the space 31.

The blade disk 4 includes a disk 43 with a filter wall 41 extending upward therefrom and a skirt portion 42 extends downward from the blade disk 4. The skirt portion 42 prevents the juice of the vegetables and/or fruits from leaking. Lower blades 44 are located at inner positions on the disk 43 and higher blades 45 are located at outer positions. Both the lower blades 44 and the higher blades 45 respectively having blade teeth (441 and 451) are oriented in radial directions and share a common center.

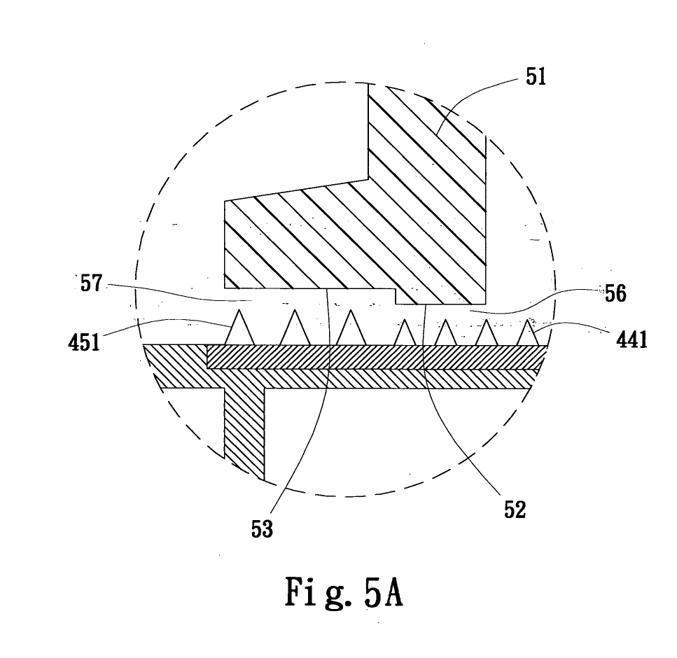

As shown in FIGS. 5 and 5A, the feeding tube 51 has the first and second stepped end surfaces 52, 53 so as to define two stepped gaps 56, 57 between the blade teeth (441 and 451) of lower and higher blades 44, 45 of the blade disk 4.

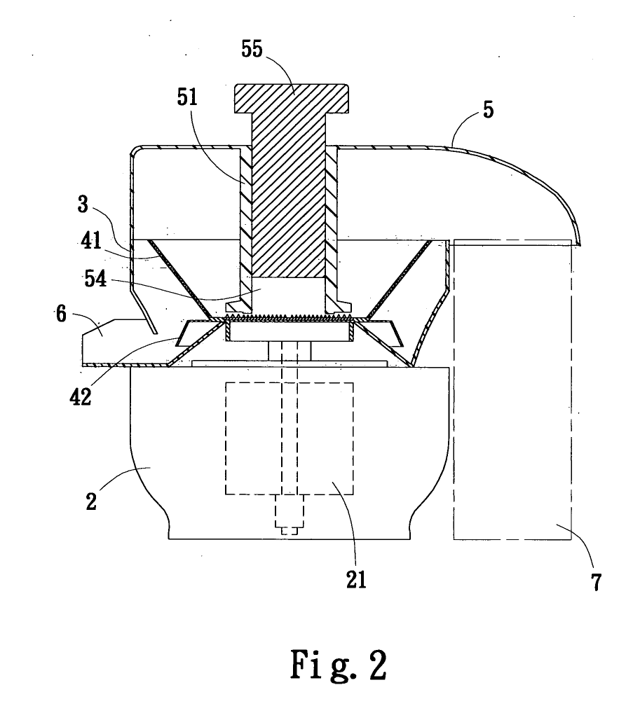

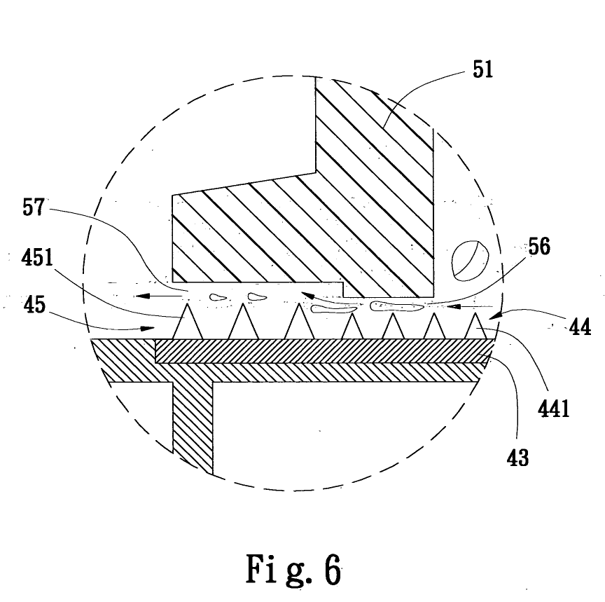

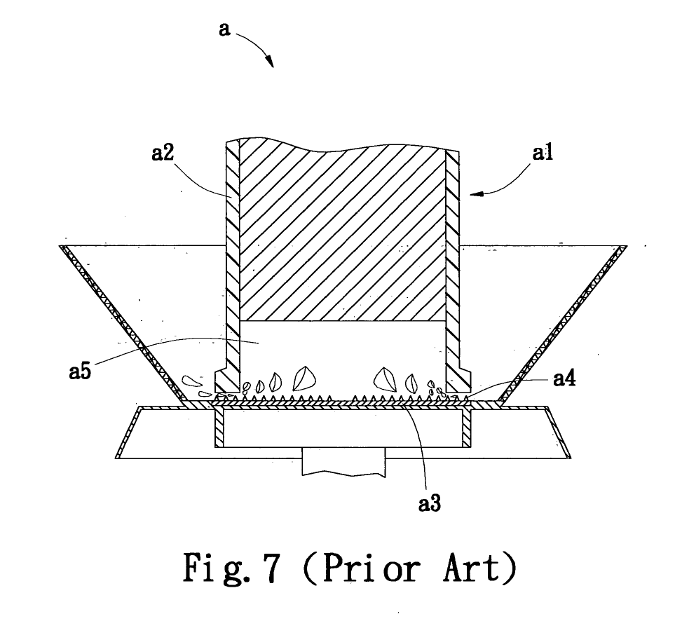

As shown in FIG. 6, when using the food processor 1, as the food including peels and seeds is inserted in the through hole 54, the lower blades 44 on the disk 43 cut the food and the peels and seeds that are not cut are pushed outward from the gap 56 to the other gap 57. Because the higher blades 45 are higher than the lower blade 44, the peels and the seeds are than cut by the higher blades 45. The juice of the food flows out from the outlet 6 of the lower cap 3. The dreg of the good is then collected in the collection box 7 as shown in FIG. 2.

While we have shown and described the embodiment in accordance with the present invention, it should be clear to those skilled in the art that further embodiments may be made without departing from the scope of the present invention.

What is claimed is:

1. A food processor (1) comprising:
a base (2), a lower cap (3), a blade disk (4) and a top cap (5), the top cap (5) having a feeding tube (51) which has a through hole (54), a plunger (55) movably inserted in the feeding tube (51), the lower cap (3) having a space (31) defined therein and the blade disk (4) received in the space (31), the base (2) having a motor (21) received therein and the motor (21) having a connection portion (22) which is connected to the blade disk (4), the blade disk (4) having a disk (43) on which lower blades (44) located at inner positions on the disk (43) and higher blades (45) located at outer positions, the feeding tube (51) having first and second stepped end surfaces (52, 53) so as to define two stepped gaps (56, 57) between the lower and higher blades (44, 45) of the blade disk (4).

2. The food processor as claimed in claim 1, wherein the feeding tube (51) of the top cap (5) is a cylindrical tube with stepped end surfaces (52, 53).

3. The food processor as claimed in claim 1, wherein the blade disk (4) includes a filter wall (41) extending upward therefrom and a skirt portion (42) extends downward from the blade disk (4) prevents the juice of the vegetables and/or fruits from leaking.

4. The food processor as claimed in claim 1 further comprising a collection box (7) connected to an underside of the top cap (5).
